(19) United States
(12) Patent Application Publication
(10) Pub. No.: US 2013/0043058 A1
(43) Pub. Date: Feb. 21, 2013

(54) ADHESIVE FILM AND FLAT CABLE

(71) Applicant: Daisuke SHANAI, Hitachi (JP)

(72) Inventor: Daisuke SHANAI, Hitachi (JP)

(73) Assignee: HITACHI CABLE, LTD., Tokyo (JP)

(21) Appl. No.: 13/434,095

(22) Filed: Mar. 29, 2012

(30) Foreign Application Priority Data
Aug. 17, 2011 (JP) 2011-178414

(51) Int. Cl. H01B 5/14; B32B 27/34

(52) U.S. Cl. 174/126.4; 428/354; 428/339

(57) ABSTRACT

An adhesive film includes an insulation film, an adhesive layer formed on the insulation film and including a copolyamide resin being soluble in a solvent at a room temperature (25° C.) and having a melting point of not less than 100° C. and not more than 150° C., a halogen-free flame retardant at a rate of not less than 100 parts by mass and not more than 250 parts by mass relative to 100 parts by mass of the copolyamide resin, and a carbodiimide compound soluble in the solvent at the room temperature (25° C.), and a conductor adhesion layer laminated on the adhesive layer.

The present application is based on Japanese patent application No. 2011-178414 filed on Aug. 17, 2011, the entire contents of which are incorporated herein by reference.

### BACKGROUND OF THE INVENTION

1. Field of the Invention

This invention relates to an adhesive film and a flat cable.

2. Description of the Related Art

In general, a flat cable is a thin cable excellent in flexibility in which plural conductors arranged in parallel are sandwiched and coated with two films with adhesive layer thereon (hereinafter, referred to as “adhesive film”). Taking an advantage of such characteristics, the flat cable is widely used as an internal cable in various electrical and electronic equipments, e.g., office automation equipments such as printer or scanner, computer equipments, video equipments such as flat-screen television, audio equipments, robots and ultrasonic diagnostic equipments, etc.

The flat cable which is used as an internal wiring material for electric equipment as described above needs to meet the UL standard and is thus required to have high flame retardancy. To solve such a problem, there is a method to flame-retard an adhesive film which covers a conductor of the flat cable. In many cases, an adhesive layer is formed on an insulation film as a base material by wet-coating of an adhesive dissolved in a solvent to manufacture the adhesive film for covering the conductors of the flat cable.

The insulation film is a film formed of engineering plastic which is excellent in heat resistance and chemical resistance. Especially, a film made of polyethylene terephthalate (PET) which is excellent in cost and supply stability is generally used. A surface of the PET film on which an adhesive is applied is corona-treated or UV-treated in order to improve adhesion between the PET film and the adhesive.

Methods of imparting flame retardancy to a flat cable include a method in which an insulation film itself is made less likely to be burnt and a method in which an adhesive is flame-retarded.

The method of flame-retarding the insulation film itself includes a method in which a film made of a resin having a self-extinguishing property such as a polyimide resin is used, and a method in which a halogen-based flame retardant is added. However, the film made of a resin having a self-extinguishing property is very expensive and is used only for a special purpose. Meanwhile, a halide generates dioxin if being burnt under inappropriate conditions and raises health and environmental concerns. Therefore, a method in which a flame retardant not containing a halide is added to an adhesive has become widely used.

As a base resin for forming an adhesive layer, a thermoplastic polyester resin which has especially good adhesion with a polyethylene terephthalate resin is widely used. There are amorphous and crystalline thermoplastic polyester resins. The amorphous resin is very soluble in a universal organic solvent and is thus widely used as a resin for forming a coating material by which an adhesive layer of a general purpose flat cable is formed by wet-coating. However, there is a problem that it is not possible to use the amorphous resin for heat resistant purpose due to its low heat resistance.

Accordingly, as a method of imparting heat resistance to an amorphous resin, a hardener is added to introduce a cross-linked structure. However, a significant effect is less likely to be obtained by the method of improving heat resistance by introducing a cross-linked structure into amorphous polyester as compared to introduction of a crystalline resin. In addition, when the cross-linked structure is excessively introduced, hot-melt of the adhesive layer is less likely to occur at the time of manufacturing a flat cable and a sufficient adhesion force may not be obtained.

On the other hand, the crystalline resin has good heat resistance and can be used as a resin for forming an adhesive layer of a flat cable for heat resistant purpose. However, a crystalline polyester resin tends not to be dissolved in a solvent due to crystallinity thereof and is thus hardly dissolved in a universal organic solvent. Accordingly, a possible method is to make a coating material by dissolving a crystalline polyester resin in a chlorinated organic solvent having particularly high solubility, such as methylene chloride, etc., followed by wet-coating thereof to form an adhesion layer. However, the chlorinated organic solvent raises concerns about adverse effects on human body and environment, and thus tends to be less used.

Furthermore, a method of manufacturing a flat cable by thin extrusion using an extruder is proposed in order to use a crystalline polyester resin (see, e.g., JP-A-2002-367458).

### SUMMARY OF THE INVENTION

However, the method of manufacturing a flat cable disclosed in JP-A-2002-367458 needs a large equipment and tends to require more manufacturing cost than wet-coating technique. Furthermore, when the base resin contains a high proportion of flame retardant, melt viscosity increases and it is difficult to extrude thinly and uniformly.

In any of the above cases, it is necessary to form a primer layer in order to improve adhesion between an insulation film and an adhesive layer. Although the primer layer is thin, a flame retardant cannot be added thereto without limit for the purpose of improving adhesion. Therefore, flame retardancy in case of including a primer layer tends to be lower than the case where an adhesive containing a flame retardant is directly applied to an insulation film without forming a primer layer.

Accordingly, it is an object of the invention to provide an adhesive film that has excellent adhesion and heat resistance without using a primer layer, as well as a flat cable.

(1) According to one embodiment of the invention, an adhesive film comprises:

an insulation film;

an adhesive layer formed on the insulation film and comprising a copolyamide resin being soluble in a solvent at a room temperature (25° C.) and having a melting point of not less than 100° C. and not more than 150° C., a halogen-free flame retardant at a rate of not less than 100 parts by mass and not more than 250 parts by mass relative to 100 parts by mass of the copolyamide resin, and a carbodiimide compound soluble in the solvent at the room temperature (25° C.); and

a conductor adhesion layer laminated on the adhesive layer.

In the above embodiment (1) of the invention, the following modifications and changes can be made.

(i) The solvent that the copolyamide resin in the adhesive layer is soluble therein comprises a mixed solvent of two solvents having a boiling point of not more than 140° C. and not containing halogen.

(ii) The mixed solvent comprises a mixture of toluene and an alcohol or a mixture of methylcyclohexane and n-propyl alcohol.

(iii) The halogen-free flame retardant in the adhesive layer comprises one or more flame retardants selected from the group consisting of a phosphorus compound, a nitrogen compound and a metal compound.

(iv) The carbodiimide compound in the adhesive layer is contained at a rate of not less than 2.5 parts by mass and not more than 15 parts by mass relative to 100 parts by mass of the copolyamide resin.

(v) The conductor adhesion layer comprises a halogen-free solvent-soluble resin that is soluble in a solvent having a boiling point of not more than 120° C. and not containing halogen.

(vi) The conductor adhesion layer further comprises not less than 5 parts by mass and not more than 100 parts by mass of a halogen-free flame retardant relative to 100 parts by mass of the halogen-free solvent-soluble resin.

(vii) The halogen-free flame retardant in the conductor adhesion layer comprises one or more flame retardants selected from the group consisting of a phosphorus compound, a nitrogen compound and a metal compound.

(viii) The insulation film comprises a polyethylene terephthalate film having a thickness of not less than 9 μm and not more than 35 μm.

(2) According to another embodiment of the invention, a flat cable comprises:

a conductor; and

a pair of adhesive films each comprising: an insulation film; an adhesive layer formed on the insulation film; and a conductor adhesion layer laminated on the adhesive layer, the adhesive layer comprising a copolyamide resin being soluble in a solvent at a room temperature (25° C.) and having a melting point of not less than 100° C. and not more than 150° C., a halogen-free flame retardant at a rate of not less than 100 parts by mass and not more than 250 parts by mass per 100 parts by mass of the copolyamide resin, and a carbodiimide compound soluble in the solvent at the room temperature (25° C.),

wherein the pair of adhesive films are arranged such that the conductor adhesion layers face each other and are bonded to each other with the conductor interposed therebetween to cover the conductor.

### EFFECTS OF THE INVENTION

According to one embodiment of the invention, an adhesive film can be provided that has excellent adhesion and heat resistance without using a primer layer, as well as a flat cable.

### BRIEF DESCRIPTION OF THE DRAWINGS

Next, the present invention will be explained in more detail in conjunction with appended drawings, wherein:

FIG. 1 is a cross sectional view showing an example of a structure of an adhesive film in a first embodiment of the present invention; and

FIG. 2 is a cross sectional view showing an example of a structure of a flat cable in a second embodiment of the invention.

### DETAILED DESCRIPTION OF THE PREFERRED EMBODIMENTS

Embodiments of the invention will be described below in reference to the drawings. It should be noted that constituent elements having substantially the same function are denoted by the same reference numerals and the overlapping explanation will be omitted.

### Summary of Embodiments

The present embodiment is an adhesive film provided with an adhesive layer formed on an insulation film and a conductor adhesion layer laminated on the adhesive layer, wherein the adhesive layer contains a copolyamide resin being soluble in a solvent at a room temperature (25° C.) and having a melting point of not less than 100° C. and not more than 150° C., a halogen-free flame retardant contained in an amount of not less than 100 parts by mass and not more than 250 parts by mass per 100 parts by mass of the copolyamide resin and a carbodiimide compound soluble in the solvent at a room temperature (25° C.).

Since the copolyamide resin which is soluble in a solvent at a room temperature (25° C.) and has a melting point of not less than 100° C. and not more than 150° C. is contained as a base resin of the adhesive layer, the base resin is soluble in an organic solvent not containing halogen (halogen-free) and heat resistance is improved. In addition, since the adhesive layer contains not less than 100 parts by mass and not more than 250 parts by mass of a halogen-free flame retardant per 100 parts by mass of the copolyamide resin, it is possible to impart flame retardancy to the adhesive film. Furthermore, since the carbodiimide compound soluble in the solvent at a room temperature (25° C.) is contained in the adhesive layer, adhesion is improved.

### First Embodiment

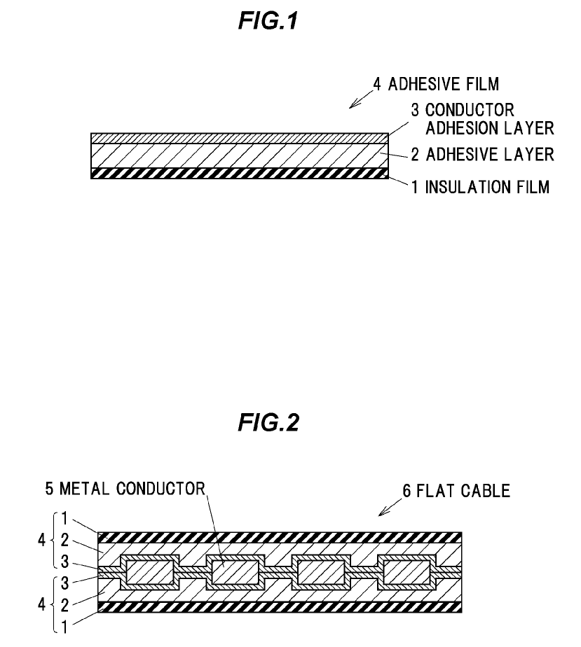

FIG. 1 is a cross sectional view showing an example of a structure of an adhesive film in a first embodiment of the invention. An adhesive film 4 is composed of an insulation film 1, an adhesive layer 2 formed on the insulation film 1 and a conductor adhesion layer 3 formed on the adhesive layer 2. The adhesive layer 2 contains a copolyamide resin being soluble in a solvent at a room temperature (25° C.) and having a melting point of not less than 100° C. and not more than 150° C., a halogen-free flame retardant contained in an amount of not less than 100 parts by mass and not more than 250 parts by mass per 100 parts by mass of the copolyamide resin and a carbodiimide compound soluble in the solvent at a room temperature (25° C.). Each constituent element will be specifically described below.

Insulation Film

The insulation film 1 can be composed of, e.g., polyester resins, polyphenylene sulfide resins or polyimide resins, etc. The polyester resins include, e.g., polyethylene terephthalate resin, polybutylene terephthalate resin, polyethylene naphthalate resin, polybutylene naphthalate resin, poly(trimethylene terephthalate) resin, polytrimethylene naphthalate resin, polycyclohexane-dimethyl terephthalate resin, polycyclohexane dimethyl naphthalate resin, polyarylate resin, etc. It is possible to preferably use a PET film composed of a polyethylene terephthalate (PET) resin which is, among the resins above, excellent in heat resistance and chemical resistance, is widely available in significant quantities and is excellent in cost and supply stability. The thickness of the insulation film 1 is preferably not less than 9 μm and not more than 35 μm. Heat resistance of the adhesive film 4 may be insufficient when less than 9 μm, and folding characteristics may be poor when more than 35 μm due to lack of flexibility. In addition, the thicker the PET, the lower the flame retardant effect and the more it is likely to burn. The thickness of the insulation film 1 has a predetermined relation with the thicknesses of the adhesive layer 2 and the conductor adhesion layer 3 as described later.

Adhesive Layer

The adhesive layer 2 used for the present embodiment contains a copolyamide resin as a base resin, a halogen-free flame retardant and a carbodiimide compound as described above.

Copolyamide Resin

A base resin contained in the adhesive layer 2 is required to be a crystalline resin soluble in a solvent, especially in an organic solvent not containing halogen (halogen-free), at a room temperature (25° C.) and having a melting point of not less than 100° C. and not more than 150° C. In the present embodiment, a copolyamide resin is used as a resin which satisfies such requirements. The reason for using a copolyamide resin as a base resin will be further specifically described below.

As described above, it is preferable that a crystalline resin excellent in heat resistance be used as a base resin constituting the adhesive layer 2. In general, the crystalline resin has excellent heat resistance within a temperature range lower than the melting point. However, a general crystalline resin excellent in heat resistance is less likely to be dissolved in a general-purpose solvent due to very high crystal cohesion. Although the crystalline resin can be dissolved in a chlorinated organic solvent containing halogen, it is not preferable due to concerns about adverse effects on human body and environment. Therefore, the solvent is preferably an organic solvent not containing halogen (halogen-free). In addition, the boiling point of the solvent is preferably not more than 140° C. This is because, when the boiling point of the solvent is more than 140° C., a drying temperature needs to be more than the boiling point in a drying step performed after applying a halogen-free resin composition for the adhesive layer 2 formed by dissolving the above-mentioned resin, and further, drying time is longer than that for a solvent having a low boiling point, which may result in that a PET film is deformed by heat.

Such crystalline resins include crystalline polyethylene, nylon, polyester and copolyamide, etc., and among the above, the crystalline polyethylene, nylon and polyester are hardly dissolved in an organic solvent not containing halogen (halogen-free) and having a boiling point of not more than 140° C. at room temperature as described above. While the crystalline polyethylene, nylon and polyester are soluble in a chlorinated organic solvent, use of such a solvent is not preferable due to concerns about adverse effects on human body and environment as described for the conventional technology. However, a copolyamide resin is soluble in the solvent described above and is thus used as a based resin constituting the adhesive layer 2 in the invention.

The melting point of the copolyamide resin is preferably not less than 100° C. and not more than 150° C. Sufficient heat resistance of the adhesive layer 2 may not be obtained when the melting point is less than 100° C. while the insulation film 1 may be deformed by heat at the time of lamination when melting point is more than 150° C. since a laminating temperature for manufacturing a flat cable 6 needs to be set to higher than the melting point. Considering heat resistance and thermal deformation at the time of lamination, the melting point of not less than 110° C. and not more than 140° C. is more preferable.

Furthermore, the copolyamide resin described above may have a molecule containing a dimerized fatty acid with a carbon number of 36 or 44. Use of especially the copolyamide resin in which a dimerized and polymerized fatty acid as a dimerized fatty acid with a carbon number of 36 or 44 is contained in a molecular structure allows flexibility and high adhesion to be obtained due to the large carbon number and high-polar amide bond.

A solvent in which the copolyamide resin of the adhesive layer 2 can be dissolved preferably has a boiling point of not more than 140° C. as described above. In other words, the copolyamide resin is a crystalline resin but is soluble in a halogen-free organic solvent having a boiling point of not more than 140° C. In addition, a solvent dissolving the copolyamide resin is preferably a mixed solvent composed of two solvents not containing halogen. Such mixed solvents having a boiling point of not more than 140° C. and composed of two solvents not containing halogen (halogen-free) include a mixture of toluene and alcohols such as, e.g., methanol, ethanol or isopropyl alcohol, etc., or a mixture of methylcyclohexane and n-propyl alcohol, etc. Note that, a crystalline copolyamide resin is hardly dissolved in toluene, methylcyclohexane and alcohols used alone. The mixed solvent preferably has a mixture ratio of toluene to alcohols in a range of 95:5 to 5:95 and that of methylcyclohexane to n-propyl alcohol in a range of 60:40 to 20:80.

Halogen-Free Flame Retardant

The amount of the halogen-free flame retardant contained in the adhesive layer 2 is not less than 100 parts by mass and not more than 250 parts by mass per 100 parts by mass of the copolyamide resin. It is not possible to obtain sufficient flame retardancy when the content of the halogen-free flame retardant is less than 100 parts by mass, and it is not possible to maintain sufficient adhesion with the below-described conductor adhesion layer 3 and with the insulation film 1 when more than 250 parts by mass.

As the halogen-free flame retardant, one or more flame retardants selected from the group consisting of phosphorus compounds, nitrogen compounds and metal compounds can be used. These halogen-free flame retardant compounds may be used alone or in combination of two or more.

The phosphorus compounds include, e.g., metal phosphate, phosphate, melamine polyphosphate, ammonium polyphosphate, phosphate ester and phosphazene compound, etc.

The nitrogen compounds include, e.g., melamine sulfate, guanidine compound, melamine compound and 1,3,5-triazine derivative, etc.

The metal compounds include, e.g., magnesium hydroxide, aluminum hydroxide, zinc stannate, hydroxy zinc stannate, zinc borate, calcium borate and zinc sulfide, etc.

Carbodiimide Compound

The carbodiimide compound contained in the adhesive layer 2 reacts with active hydrogen of both the copolyamide resin contained in the adhesive layer 2 and the insulation film 1, and thus has an effect of increasing adhesion. Here, the carbodiimide compound is a compound having at least one carbodiimide group (—N═C═N—) per molecule, and includes, e.g., carbodiimide compounds obtained from diisopropylcarbodiimide, dicyclohexylcarbodiimid, 1-ethyl-3-(3-dimethylaminopropyl)carbodiimide hydrochloride, N-[3-(dimethylamino)propyl]-N′-ethylcarbodiimide or N,N′-di-p-tolylcarbodiimide with hexamethylene diisocyanate or 4,4′-diphenylmethane diisocyanate, etc., and derivatives having a skeleton of carbodiimide compound.

In addition, the carbodiimide compound needs to be soluble in a solvent, preferably in a mixed solvent, which dissolves the copolyamide resin at a room temperature (25° C.).

The content of the carbodiimide compound is preferably not less than 2.5 parts by mass and not more than 15 parts by mass per 100 parts by mass of the copolyamide resin constituting the adhesive layer 2, and more preferably, not less than 5 parts by mass and not more than 10 parts by mass. It may not be possible to obtain a sufficient effect when less than 2.5 parts by mass, and an adhesion force may be reduced when more than 15 parts by mass.

The adhesive layer 2 can appropriately contain antioxidant, copper inhibitor, antiblocking agent, colorant, thickener, cross-linking agent, crosslinking aid, antistatic agent, ultraviolet absorber, light stabilizer and hydrolysis inhibitor, etc.

It is preferable that the adhesive layer 2 be thicker than the insulation film 1. Sufficient flame retardancy may not be obtained when thinner than the insulation film 1.

Conductor Adhesion Layer

As a base resin constituting the conductor adhesion layer 3 used in the present embodiment, it is possible to use, e.g., a resin which is soluble in a solvent not containing halogen (halogen-free) and having a boiling point of not more than 120° C. (halogen-free solvent-soluble resin). When the boiling point of the solvent is more than 120° C., a drying temperature in a drying step performed after applying a coating material needs to be more than the boiling point at the time of manufacturing the conductor adhesion layer 3, and also drying time is longer than that for a solvent having a low boiling point, which may result in that the adhesive layer 2 thereunder may be deformed by heat.

Here, the solvent having a boiling point of not more than 120° C. includes toluene, cyclohexane, methylcyclohexane, methyl ethyl ketone, acetone, ethyl acetate, n-propyl alcohol, isopropyl alcohol, methanol and ethanol, etc. These solvents may be used alone or in combination of two or more.

In detail, the halogen-free solvent-soluble resins as a base resin can include thermoplastic polyurethane, amorphous polyester and copolyamide resin, etc., which are soluble in the solvent described above. These resins exhibit good adhesion with copper or tin plated copper constituting a metal conductor 5 when the metal conductor 5 is covered by the adhesive films 4 of the invention to form the flat cable 6. Especially, an amorphous polyester resin which is excellent in solvent-solubility and has good adhesion with the metal conductor 5 is preferably used.

It is preferable that the conductor adhesion layer 3 contain a halogen-free flame retardant. In case that the halogen-free flame retardant is contained, the content thereof is preferably not less than 5 parts by mass and not more than 100 parts by mass per 100 parts by mass of the halogen-free solvent-soluble resin constituting the conductor adhesion layer 3. A sufficient adhesion force with the conductor which is required for the conductor adhesion layer 3 as a layer adhered to the conductor in the flat cable 6 may not be obtained when more than 100 parts by mass while the flame retardant effect may be insufficient when less than 5 parts by mass. The flame retardant which can be contained in the conductor adhesion layer 3 can be, e.g., the same as the flame retardants used for the adhesive layer 2.

As the halogen-free flame retardant contained in the conductor adhesion layer 3, one or more flame retardants selected from the group consisting of, e.g., phosphorus compounds, nitrogen compounds and metal compounds can be used. The phosphorus compounds, nitrogen compounds and metal compounds can be, e.g., the same as those used for the adhesive layer 2.

To the conductor adhesion layer 3, it is possible to appropriately add antioxidant, copper inhibitor, antiblocking agent, colorant, thickener, cross-linking agent, crosslinking aid, antistatic agent, ultraviolet absorber, light stabilizer and hydrolysis inhibitor.

The conductor adhesion layer 3 must be thinner than the insulation film 1. Sufficient flame retardancy may not be obtained when thicker than the insulation film 1. In sum, the thickness relation is preferably Tc<Ta<Tb where the thickness of the insulation film 1 is Ta, the thickness of the adhesive layer 2 is Tb and the thickness of the conductor adhesion layer 3 is Tc.

### Effects of the First Embodiment

The adhesive film 4 of the present embodiment has the following effects.

(a) Since the copolyamide resin which is soluble in a solvent at a room temperature (25° C.) and has a melting point of not less than 100° C. and not more than 150° C. is contained as a base resin of the adhesive layer 2, the base resin is soluble in a halogen-free organic solvent and heat resistance is improved.

(b) Since the adhesive layer 2 contains not less than 100 parts by mass and not more than 250 parts by mass of a halogen-free flame retardant per 100 parts by mass of the copolyamide resin, it is possible to impart flame retardancy to the adhesive film 4.

(c) Since the carbodiimide compound soluble in the halogen-free organic solvent at a room temperature (25° C.) is contained in the adhesive layer 2, adhesion is improved.

### Second Embodiment

FIG. 2 is a cross sectional view showing an example of a structure of a flat cable in a second embodiment of the invention. The flat cable 6 is composed of two adhesive films 4 arranged so that surfaces of the conductor adhesion layers 3 of the adhesive films 4 shown in FIG. 1 face each other, and plural metal conductors 5 arranged in parallel to each other.

The metal conductor 5 can be formed of, e.g., a conductive material such as a copper-based material formed of copper or copper alloy, an iron-based material formed of iron or iron alloy and an aluminum-based material formed of aluminum or aluminum alloy. The copper-based material can include, e.g., oxygen-free copper, tough-pitch copper and phosphor bronze, etc. Alternatively, the metal conductor 5 may be plated with metal such as Sn or Ni, etc. An Sn-plating coat is formed on a surface of a core material having a rectangular cross section with, e.g., a thickness of not less than 20 μm and not more than 60 μm and a width of not less than 0.25 mm and not more than 1.3 mm, so-called rectangular conductor, thereby forming the metal conductor 5 shown in FIG. 2. Alternatively, at least one or more elements selected from P, Ge, Ga, Zn and Al may be added to the Sn-plating coat. In addition, the metal conductor 5 is not limited to a rectangular conductor and it is possible to use a well-known conductor for flat cable.

To form the flat cable 6 in the present embodiment, for example, two adhesive films 4 are arranged so that the respective conductor adhesion layers 3 face each other, plural metal conductors 5 are arranged in parallel between the conductor adhesion layers 3, and subsequently, the conductor adhesion layers 3 are bonded by a laminating machine.

### Effects of the Second Embodiment

In the second embodiment, by using an adhesive film which has an adhesive layer made of a copolyamide resin and is thus excellent in flame retardancy, adhesion and heat resistance without providing a primer layer, it is possible to provide a flat cable excellent in flame retardancy and heat resistance.

### EXAMPLES

Although the invention will be described further in detail below in reference to Examples, the invention is not intended to be limited by the examples. Tables 1 and 2 show compositions of adhesive 3 and characteristics evaluation results of solvent-solubility and heat resistance in Examples 1 to 25. Table 3 shows compositions of adhesive 3 and characteristics evaluation results of solvent-solubility and heat resistance in Comparative Examples 1 to 6. Table 4 shows compositions of conductor adhesion layer and characteristics evaluation results of solvent-solubility. Table 5 shows a combination of a conductor adhesion layer with an adhesive layer and characteristics evaluation results of solvent-solubility, heat resistance, adhesion and flame retardancy in Examples 1 to 13. Table 6 shows a combination of a conductor adhesion layer with an adhesive layer and characteristics evaluation results of solvent-solubility, heat resistance, adhesion and flame retardancy in Examples 14 to 25. Table 7 shows a combination of a conductor adhesion layer with an adhesive layer and characteristics evaluation results of solvent-solubility, heat resistance, adhesion and flame retardancy in Comparative Examples 1 to 6.

Solvent-Solubility Evaluation of Base Resin of Adhesive Layer

Solvent-solubility of a base resin contained in the adhesive layer 2 was evaluated. Under the conditions that the base resin is 10 parts by mass in solid content concentration and a ratio of toluene to alcohols (isopropyl alcohol, methanol or ethanol) is in a range of 5:95 to 95:5, the resin which was dissolved at a room temperature (25° C.) was judges as passed in the solvent-solubility test and the resin which was not dissolved was judges as failed in the test. The results are shown in Tables 5 to 7.

Heat Resistance Evaluation of Base Resin of Adhesive Layer

Heat resistance of the base resin contained in the adhesive layer 2 was evaluated. As for heat resistance, an adhesive used for the adhesive layer 2 was applied to a flat and smooth aluminum plate to form a 25 μm-thick adhesive layer 2, load was applied thereon at pressure of 1 MPa by a cylindrical aluminum bar with a tip length of 3 mm and a diameter of 1 mm, and it was kept in this state in a constant-temperature oven at 85° C. for 24 hours. The result with no conduction between the aluminum plate and the aluminum bar after 24 hours was judges as passed in the test and the result with conduction therebetween was judges as failed in the test. The results are shown in Tables 5 to 7.

The UL VW-1 test in accordance with UL 758 AWM was conducted on the flat cable 6 manufactured as described above and the flame retardancy was evaluated. The result was judged as ⊚ (excellent) when 5 out of 5 test pieces are passed in the test, ◯ (good) when 3 to 4 test pieces are passed in the test, Δ (acceptable) when 1 to 2 test pieces are passed in the test, and X (bad) when all test pieces are failed in the test.

A 180° peeling test of a tin-plated metal conductor 5 (at a tension rate of 50 mm/min) was conducted on a terminal portion of the flat cable 6 manufactured as described above, and peel strength was evaluated. The peel strength of not less than 0.7 kN/m was judged as ⊚, not less than 0.6 kN/m and less than 0.7 kN/m was judges as ◯, not less than 0.5 kN/m and less than 0.6 kN/m was judges as Δ, and less than 0.5 kN/m was judges as X. Note that, the flame retardancy and the peel strength are satisfactory unless it is indicated by “X”.

### Example 1

A 12 μm-thick PET film (trade name: Lumirror, manufactured by Toray Industries, Inc.) was used as the insulation film 1, and an adhesive as the adhesive layer 2 having the composition 1 shown in Table 1 (100 parts by mass of copolyamide resin (trade name: TPAE31, manufactured by Fuji Kasei Kogyo Co., Ltd.), 150 parts by mass of metal phosphate as a flame retardant (trade name: Exolit OP935, manufactured by Clariant Corporation) and 5 parts by mass of carbodiimide compound in solid content (trade name: V-03, manufactured by Nisshinbo Chemical Inc.) was applied to, using a slot die coater, and dried on a corona-treated surface of the PET film, thereby forming a 24 μm-thick adhesive layer 2.

Next, an adhesive as the conductor adhesion layer 3 having the composition A shown in Table 4 (70 parts by mass of polyester resin (trade name: Vylon 670, manufactured by Toyobo Co., Ltd.), 30 parts by mass of polyester resin (trade name: Vylon 200, manufactured by Toyobo Co., Ltd.) and 50 parts by mass of magnesium hydroxide as a flame retardant (trade name: Kisuma 5L, manufactured by Kyowa Chemical Industry Co. Ltd.)) was applied to, using a slot die coater, and dried on the adhesive layer 2 to form a 4 μm-thick conductor adhesion layer 3, thereby making the adhesive film 4.

Then, 50 tin-plated copper rectangular soft conductors with a width of 0.3 mm and a thickness of 35 μm as the metal conductor 5 were arranged in parallel at a pitch of 0.5 mm between the obtained two adhesive films 4 and lamination was carried out, thereby making the flat cable 6. It was confirmed that the flat cable 6 is passed in all of the test items.

### Example 2

In Example 2, the thickness of the PET film was 25 μm, which is different from Example 1. In addition, the thickness and composition of the adhesive layer 2 in Example 2 were 36 μm and the composition 2 in Table 1, which are different from Example 1. Furthermore, the composition of the conductor adhesion layer 3 in Example 2 was the composition B in Table 4, which is different from Example 1. It was confirmed that the flat cable 6 manufactured in the same manner as Example 1 is passed in all of the test items.

### Example 3

In Example 3, the thicknesses of the PET film, the adhesive layer 2 and the conductor adhesion layer 3 were the same as that in Example 1 but materials of the adhesive layer 2 and the conductor adhesion layer 3 were different, where the composition 3 in Table 1 was used for the adhesive layer 2 and the composition C in Table 4 was used for the conductor adhesion layer 3. It was confirmed that the flat cable 6 manufactured in the same manner as Example 1 is passed in all of the test items.

### Example 4

In Example 4, the thicknesses of the PET film, the adhesive layer 2 and the conductor adhesion layer 3 were the same as that in Example 2 but materials of the adhesive layer 2 and the conductor adhesion layer 3 were different, where the composition 4 in Table 1 was used for the adhesive layer 2 and the composition D in Table 4 was used for the conductor adhesion layer 3. It was confirmed that the flat cable 6 manufactured in the same manner as Example 1 is passed in all of the test items.

### Example 5

In Example 5, the thicknesses of the PET film, the adhesive layer 2 and the conductor adhesion layer 3 were the same as that in Example 1 but a material of the adhesive layer 2 was different, where the composition 5 in Table 1 was used for the adhesive layer 2 while the composition A in Table 4 which is the same as Example 1 was used for the conductor adhesion layer 3. It was confirmed that the flat cable 6 manufactured in the same manner as Example 1 is passed in all of the test items.

### Example 6

In Example 6, the thicknesses of the PET film, the adhesive layer 2 and the conductor adhesion layer 3 were the same as that in Example 2 but a material of the adhesive layer 2 was different, where the composition 6 in Table 1 was used for the adhesive layer 2 while the composition B in Table 4 which is the same as Example 2 was used for the conductor adhesion layer 3. It was confirmed that the flat cable 6 manufactured in the same manner as Example 1 is passed in all of the test items.

### Example 7

In Example 7, the thicknesses of the PET film, the adhesive layer 2 and the conductor adhesion layer 3 were the same as that in Example 1 but materials of the adhesive layer 2 and the conductor adhesion layer 3 were different, where the composition 7 in Table 1 was used for the adhesive layer 2 and the composition C in Table 4 was used for the conductor adhesion layer 3. It was confirmed that the flat cable 6 manufactured in the same manner as Example 1 is passed in all of the test items.

### Example 8

In Example 8, the thicknesses of the PET film, the adhesive layer 2 and the conductor adhesion layer 3 were the same as that in Example 2 but materials of the adhesive layer 2 and the conductor adhesion layer 3 were different, where the composition 8 in Table 1 was used for the adhesive layer 2 and the composition D in Table 4 was used for the conductor adhesion layer 3. It was confirmed that the flat cable 6 manufactured in the same manner as Example 1 is passed in all of the test items.

### Example 9

In Example 9, the thicknesses of the PET film, the adhesive layer 2 and the conductor adhesion layer 3 were the same as that in Example 1 but a material of the adhesive layer 2 was different, where the composition 9 in Table 1 was used for the adhesive layer 2 while the composition A in Table 4 which is the same as Example 1 was used for the conductor adhesion layer 3. It was confirmed that the flat cable 6 manufactured in the same manner as Example 1 is passed in all of the test items.

### Example 10

In Example 10, the thicknesses of the PET film, the adhesive layer 2 and the conductor adhesion layer 3 were the same as that in Example 2 but a material of the adhesive layer 2 was different, where the composition 10 in Table 1 was used for the adhesive layer 2 while the composition B in Table 4 which is the same as Example 2 was used for the conductor adhesion layer 3. It was confirmed that the flat cable 6 manufactured in the same manner as Example 1 is passed in all of the test items.

### Example 11

In Example 11, the thicknesses of the PET film, the adhesive layer 2 and the conductor adhesion layer 3 were the same as that in Example 1 but materials of the adhesive layer 2 and the conductor adhesion layer 3 were different, where the composition 11 in Table 1 was used for the adhesive layer 2 and the composition C in Table 4 was used for the conductor adhesion layer 3. It was confirmed that the flat cable 6 manufactured in the same manner as Example 1 is passed in all of the test items.

### Example 12

In Example 12, the thicknesses of the PET film, the adhesive layer 2 and the conductor adhesion layer 3 were the same as that in Example 2 but materials of the adhesive layer 2 and the conductor adhesion layer 3 were different, where the composition 12 in Table 1 was used for the adhesive layer 2 and the composition D in Table 4 was used for the conductor adhesion layer 3. It was confirmed that the flat cable 6 manufactured in the same manner as Example 1 is passed in all of the test items.

### Example 13

In Example 13, the thicknesses of the PET film, the adhesive layer 2 and the conductor adhesion layer 3 were the same as that in Example 1 but a material of the adhesive layer 2 was different, where the composition 13 in Table 1 was used for the adhesive layer 2 while the composition A in Table 4 which is the same as Example 1 was used for the conductor adhesion layer 3. It was confirmed that the flat cable 6 manufactured in the same manner as Example 1 is passed in all of the test items.

### Example 14

In Example 14, the thicknesses of the PET film, the adhesive layer 2 and the conductor adhesion layer 3 were the same as that in Example 2 but a material of the adhesive layer 2 was different, where the composition 14 in Table 2 was used for the adhesive layer 2 while the composition B in Table 4 which is the same as Example 2 was used for the conductor adhesion layer 3. It was confirmed that the flat cable 6 manufactured in the same manner as Example 1 is passed in all of the test items.

### Example 15

In Example 15, the thicknesses of the PET film, the adhesive layer 2 and the conductor adhesion layer 3 were the same as that in Example 1 but materials of the adhesive layer 2 and the conductor adhesion layer 3 were different, where the composition 15 in Table 2 was used for the adhesive layer 2 and the composition C in Table 4 was used for the conductor adhesion layer 3. It was confirmed that the flat cable 6 manufactured in the same manner as Example 1 is passed in all of the test items.

### Example 16

In Example 16, the thicknesses of the PET film, the adhesive layer 2 and the conductor adhesion layer 3 were the same as that in Example 2 but materials of the adhesive layer 2 and the conductor adhesion layer 3 were different, where the composition 16 in Table 2 was used for the adhesive layer 2 and the composition D in Table 4 was used for the conductor adhesion layer 3. It was confirmed that the flat cable 6 manufactured in the same manner as Example 1 is passed all of the test items.

### Example 17

In Example 17, the thicknesses of the PET film, the adhesive layer 2 and the conductor adhesion layer 3 were the same as that in Example 1 but a material of the adhesive layer 2 was different, where the composition 17 in Table 2 was used for the adhesive layer 2 while the composition A in Table 4 which is the same as Example 1 was used for the conductor adhesion layer 3. It was confirmed that the flat cable 6 manufactured in the same manner as Example 1 is passed all of the test items.

### Example 18

In Example 18, the thicknesses of the PET film, the adhesive layer 2 and the conductor adhesion layer 3 were the same as that in Example 2 but a material of the adhesive layer 2 was different, where the composition 18 in Table 2 was used for the adhesive layer 2 while the composition B in Table 4 which is the same as Example 2 was used for the conductor adhesion layer 3. It was confirmed that the flat cable 6 manufactured in the same manner as Example 1 is passed all of the test items.

### Example 19

In Example 19, the thicknesses of the PET film, the adhesive layer 2 and the conductor adhesion layer 3 were the same as that in Example 1 but materials of the adhesive layer 2 and the conductor adhesion layer 3 were different, where the composition 19 in Table 2 was used for the adhesive layer 2 and the composition C in Table 4 was used for the conductor adhesion layer 3. It was confirmed that the flat cable 6 manufactured in the same manner as Example 1 is passed all of the test items.

### Example 20

In Example 20, the thicknesses of the PET film, the adhesive layer 2 and the conductor adhesion layer 3 were the same as that in Example 2 but materials of the adhesive layer 2 and the conductor adhesion layer 3 were different, where the composition 20 in Table 2 was used for the adhesive layer 2 and the composition D in Table 4 was used for the conductor adhesion layer 3. It was confirmed that the flat cable 6 manufactured in the same manner as Example 1 is passed in all of the test items.

### Example 21

In Example 21, the thicknesses of the PET film, the adhesive layer 2 and the conductor adhesion layer 3 were the same as that in Example 1 but a material of the adhesive layer 2 was different, where the composition 21 in Table 2 was used for the adhesive layer 2 while the composition A in Table 4 which is the same as Example 1 was used for the conductor adhesion layer 3. It was confirmed that the flat cable 6 manufactured in the same manner as Example 1 is passed in all of the test items.

### Example 22

In Example 22, the thicknesses of the PET film, the adhesive layer 2 and the conductor adhesion layer 3 were the same as that in Example 2 but a material of the adhesive layer 2 was different, where the composition 22 in Table 2 was used for the adhesive layer 2 while the composition B in Table 4 which is the same as Example 2 was used for the conductor adhesion layer 3. It was confirmed that the flat cable 6 manufactured in the same manner as Example 1 is passed in all of the test items.

### Example 23

In Example 23, the thicknesses of the PET film, the adhesive layer 2 and the conductor adhesion layer 3 were the same as that in Example 1 but materials of the adhesive layer 2 and the conductor adhesion layer 3 were different, where the composition 23 in Table 2 was used for the adhesive layer 2 and the composition C in Table 4 was used for the conductor adhesion layer 3. It was confirmed that the flat cable 6 manufactured in the same manner as Example 1 is passed in all of the test items.

### Example 24

In Example 24, the thicknesses of the PET film, the adhesive layer 2 and the conductor adhesion layer 3 were the same as that in Example 2 but materials of the adhesive layer 2 and the conductor adhesion layer 3 were different, where the composition 24 in Table 2 was used for the adhesive layer 2 and the composition D in Table 4 was used for the conductor adhesion layer 3. It was confirmed that the flat cable 6 manufactured in the same manner as Example 1 is passed in all of the test items.

### Example 25

In Example 25, the thicknesses of the PET film, the adhesive layer 2 and the conductor adhesion layer 3 were the same as that in Example 1 but a material of the adhesive layer 2 was different, where the composition 25 in Table 2 was used for the adhesive layer 2 while the composition A in Table 4 which is the same as Example 1 was used for the conductor adhesion layer 3. It was confirmed that the flat cable 6 manufactured in the same manner as Example 1 is passed in all of the test items.

### Comparative Example 1

In Comparative Example 1, a 12 μm-thick PET film (trade name: Lumirror, manufactured by Toray Industries, Inc.) which is the same as Example 1 was used as the insulation film 1 and thermoplastic polyurethane (trade name: UR-1350, manufactured by Toyobo Co., Ltd.) was applied on a corona-treated surface of the PET film, thereby forming a 2 μm-thick anchor coat layer. The adhesive 2 having the composition 26 in Table 3 was applied to, using a slot die coater, and dried on the anchor coat layer, thereby forming a 24 μm-thick adhesive layer 2.

Next, an adhesive having the composition A shown in Table 4 was applied to, using a slot die coater, and dried on the adhesive layer 2 to form a 4 μm-thick conductor adhesion layer 3, thereby making the adhesive film 4.

Then, 50 tin-plated rectangular soft conductors 5 with a width of 0.3 mm and a thickness of 35 μm as the metal conductor 5 were arranged in parallel at a pitch of 0.5 mm between a pair of adhesive films 4 and lamination was carried out, thereby making the flat cable 6.

In Comparative Example 1, solvent-solubility and adhesion were satisfactory but heat resistance was not satisfactory due to low melting point. In addition, Comparative Example 1 did not pass the flame resistant test since the amount of the flame retardant is small and the anchor coat layer is formed.

### Comparative Example 2

In Comparative Example 2, the thickness of the PET film was 25 μm, which is different from Comparative Example 1. In addition, the thickness and material of the adhesive layer in Comparative Example 2 were 36 μm and the composition 27 in Table 3, which are different from Comparative Example 1. Furthermore, the composition of the conductor adhesion layer in Comparative Example 2 was the composition B in Table 4, which is different from Comparative Example 1. The flat cable 6 manufactured in the same manner as Comparative Example 1 satisfied solvent-solubility and flame retardancy but did not satisfy heat resistance and adhesion.

### Comparative Example 3

In Comparative Example 3, the thicknesses of the PET film, the adhesive layer 2 and the conductor adhesion layer 3 were the same as that in Comparative Example 1 but materials of the adhesive layer 2 and the conductor adhesion layer 3 were different, where the composition 28 in Table 3 was used for the adhesive layer 2 and the composition C in Table 4 was used for the conductor adhesion layer 3. The flat cable 6 manufactured in the same manner as Comparative Example 1 satisfied solvent-solubility, flame retardancy and adhesion but did not satisfy heat resistance.

### Comparative Example 4

In Comparative Example 4, the thicknesses of the PET film, the adhesive layer 2 and the conductor adhesion layer 3 were the same as that in Comparative Example 1 but a material of the adhesive layer 2 was different, where the composition 29 in Table 3 was used for the adhesive layer 2. The copolyamide resin used for the composition 29 was not dissolved in a solvent and it was not possible to make the adhesive film 4.

### Comparative Example 5

In Comparative Example 5, the thicknesses of the PET film, the adhesive layer 2 and the conductor adhesion layer 3 were the same as that in Comparative Example 1 but a material of the adhesive layer 2 was different, where the composition 30 in Table 3 was used for the adhesive layer 2. The thermoplastic polyurethane resin used for the composition 30 was not dissolved in a solvent and it was not possible to make the adhesive film 4.

### Comparative Example 6

In Comparative Example 6, the thicknesses of the PET film, the adhesive layer 2 and the conductor adhesion layer 3 were the same as that in Comparative Example 2 but a material of the adhesive layer 2 was different, where the composition 31 in Table 3 was used for the adhesive layer 2 while the composition B in Table 4 which is the same as Comparative Example 2 was used for the conductor adhesion layer 3. The flat cable 6 manufactured in the same manner as Comparative Example 1 satisfied solvent-solubility, flame retardancy and adhesion but did not satisfy heat resistance.

It should be noted that the present invention is not intended to be limited to the embodiments and examples, and the various kinds of changes can be made without departing from the gist of the present invention.

TABLE 1
Adhesive layer (Examples)

| | | | | | Compositions | | | | | | |
|---|---|---|---|---|---|---|---|---|---|---|---|
| Items | | | | | 1 | 2 | 3 | 4 | 5 | 6 | 7 |
| Proportion of | Resin | Copolyamide | TPAE31, | MP* | 100 | | | | 100 | 100 | 100 |
| ingredients | | | Fuji Kasei | 114° C. | | | | | | | |
| (parts by mass) | | | TPAE32, | MP | | 100 | | | | | |
| | | | Fuji Kasei | 124° C. | | | | | | | |
| | | | TPAE33, | MP | | | 100 | | | | |
| | | | Fuji Kasei | 106° C. | | | | | | | |
| | | | PA102A, | MP | | | | 100 | | | |
| | | | Fuji Kasei | 146° C. | | | | | | | |
| | Flame | Metal phosphate | Exolit OP935, | — | 150 | 150 | 150 | 150 | 150 | 150 | 150 |
| | retardant | | Clariant | | | | | | | | |
| | | Phosphate | FP2100J, | — | | | | | | | |
| | | | Adeka | | | | | | | | |
| | | Melamine | Melapur | — | | | | | | | |
| | | polyphosphate | 200/70, Chiba | | | | | | | | |
| | | Melamine sulfate | Apinon-901, | — | | | | | | | |
| | | | Sanwa Chem. | | | | | | | | |
| | | 1,3,5-triazine | MC-5S, | — | | | | | | | |
| | | derivative | Sakai Chem. | | | | | | | | |
| | | Calcium borate | UBP, | — | | | | | | | |
| | | | Kinseimatec | | | | | | | | |
| | | Zinc stannate | Alcanex ZS, | — | | | | | | | |
| | | | Mizusawa Chem. | | | | | | | | |
| | | Magnesium | Kisuma 5L, | — | | | | | | | |
| | | hydroxide | Kyowa Chem. | | | | | | | | |
| | | Aluminum | Higilite | — | | | | | | | |
| | | hydroxide | H-42S, Showa | | | | | | | | |
| | | | Denko | | | | | | | | |
| | Additive | Carbodiimide | V-03, | — | 5 | 5 | 5 | 5 | | | |
| | | | Nisshinbo | | | | | | | | |
| | | | Chem. | | | | | | | | |
| | | | (solid content) | | | | | | | | |
| | | | V-05, | — | | | | | 5 | | |
| | | | Nisshinbo | | | | | | | | |
| | | | Chem. | | | | | | | | |
| | | | (solid content) | | | | | | | | |
| | | | V-07, | — | | | | | | 5 | |
| | | | Nisshinbo | | | | | | | | |
| | | | Chem. | | | | | | | | |
| | | | (solid content) | | | | | | | | |
| | | | V-09, | — | | | | | | | 5 |
| | | | Nisshinbo | | | | | | | | |
| | | | Chem. | | | | | | | | |
| | | | (solid content) | | | | | | | | |

| | | | | | | | | | |
|---|---|---|---|---|---|---|---|---|---|
| Characteristics | Solvent- | Dissolution in mixed | P* | P | P | P | P | P | P |
| Evaluation | solubility | solvent of toluene | | | | | | | |
| | | and alcohols | | | | | | | |
| | Heat | No conduction between | P | P | P | P | P | P | P |
| | resistance | plate and bar after | | | | | | | |
| | | 24 hours at 85° C. | | | | | | | |

| | | | | | Compositions | | | | | |
|---|---|---|---|---|---|---|---|---|---|---|
| Items | | | | | 8 | 9 | 10 | 11 | 12 | 13 |
| Proportion of | Resin | Copolyamide | TPAE31, | MP* | | | | 100 | | |
| ingredients | | | Fuji Kasei | 114° C. | | | | | | |
| (parts by mass) | | | TPAE32, | MP | 100 | | | | 100 | |
| | | | Fuji Kasei | 124° C. | | | | | | |
| | | | TPAE33, | MP | | 100 | | | | 100 |
| | | | Fuji Kasei | 106° C. | | | | | | |
| | | | PA102A, | MP | | | 100 | | | |
| | | | Fuji Kasei | 146° C. | | | | | | |
| | Flame | Metal phosphate | Exolit OP935, | — | 100 | 250 | | | | |
| | retardant | | Clariant | | | | | | | |
| | | Phosphate | FP2100J, | — | | | 100 | 250 | | |
| | | | Adeka | | | | | | | |
| | | Melamine | Melapur | — | | | | | 100 | |
| | | polyphosphate | 200/70, Chiba | | | | | | | |
| | | Melamine sulfate | Apinon-901, | — | | | | | | 250 |
| | | | Sanwa Chem. | | | | | | | |
| | | 1,3,5-triazine | MC-5S, | — | | | | | | |
| | | derivative | Sakai Chem. | | | | | | | |
| | | Calcium borate | UBP, | — | | | | | | |
| | | | Kinseimatec | | | | | | | |
| | | Zinc stannate | Alcanex ZS, | — | | | | | | |
| | | | Mizusawa Chem. | | | | | | | |
| | | Magnesium | Kisuma 5L, | — | | | | | | |
| | | hydroxide | Kyowa Chem. | | | | | | | |
| | | Aluminum | Higilite | — | | | | | | |
| | | hydroxide | H-42S, Showa | | | | | | | |
| | | | Denko | | | | | | | |
| | Additive | Carbodiimide | V-03, | — | 5 | | | | 5 | |
| | | | Nisshinbo | | | | | | | |
| | | | Chem. | | | | | | | |
| | | | (solid content) | | | | | | | |
| | | | V-05, | — | | 5 | | | | 5 |
| | | | Nisshinbo | | | | | | | |
| | | | Chem. | | | | | | | |
| | | | (solid content) | | | | | | | |
| | | | V-07, | — | | | 5 | | | |
| | | | Nisshinbo | | | | | | | |
| | | | Chem. | | | | | | | |
| | | | (solid content) | | | | | | | |
| | | | V-09, | — | | | | 5 | | |
| | | | Nisshinbo | | | | | | | |
| | | | Chem. | | | | | | | |
| | | | (solid content) | | | | | | | |

| | | | | | | | | |
|---|---|---|---|---|---|---|---|---|
| Characteristics | Solvent- | Dissolution in mixed | P | P | P | P | P | P |
| Evaluation | solubility | solvent of toluene | | | | | | |
| | | and alcohols | | | | | | |
| | Heat | No conduction between | P | P | P | P | P | P |
| | resistance | plate and bar after | | | | | | |
| | | 24 hours at 85° C. | | | | | | |

*MP: melting point, P: passed

TABLE 2
Adhesive layer (Examples)

| | | | | | Compositions | | | | | | |
|---|---|---|---|---|---|---|---|---|---|---|---|
| Items | | | | | 14 | 15 | 16 | 17 | 18 | 19 | 20 |
| Proportion of | Resin | Copolyamide | TPAE31, | MP | | 100 | 100 | 100 | 100 | 100 | 100 |
| ingredients | | | Fuji Kasei | 114° C. | | | | | | | |
| (parts by mass) | | | TPAE32, | MP | | | | | | | |
| | | | Fuji Kasei | 124° C. | | | | | | | |
| | | | TPAE33, | MP | | | | | | | |
| | | | Fuji Kasei | 106° C. | | | | | | | |
| | | | PA102A, | MP | 100 | | | | | | |
| | | | Fuji Kasei | 146° C. | | | | | | | |
| | Flame | Metal phosphate | Exolit OP935, | — | | | 150 | 150 | 150 | 150 | 150 |
| | retardant | | Clariant | | | | | | | | |
| | | Phosphate | FP2100J, | — | | | | | | | |
| | | | Adeka | | | | | | | | |
| | | Melamine | Melapur | — | | | | | | | |
| | | polyphosphate | 200/70, Chiba | | | | | | | | |
| | | Melamine sulfate | Apinon-901, | — | | | | | | | |
| | | | Sanwa Chem. | | | | | | | | |
| | | 1,3,5-triazine | MC-5S, | — | 100 | | 30 | | | | |
| | | derivative | Sakai Chem. | | | | | | | | |
| | | Calcium borate | UBP, | — | | 250 | | 30 | | | |
| | | | Kinseimatec | | | | | | | | |
| | | Zinc stannate | Alcanex ZS, | — | | | | | 30 | | |
| | | | Mizusawa Chem. | | | | | | | | |
| | | Magnesium hydroxide | Kisuma 5L, | — | | | | | | 30 | |
| | | | Kyowa Chem. | | | | | | | | |
| | | Aluminum hydroxide | Higilite | — | | | | | | | 30 |
| | | | H-42S, Showa | | | | | | | | |
| | | | Denko | | | | | | | | |
| | Additive | Carbodiimide | V-03, | — | | | 2.5 | 5 | 10 | 15 | 20 |
| | | | Nisshinbo | | | | | | | | |
| | | | Chem. | | | | | | | | |
| | | | (solid content) | | | | | | | | |

| | | | |
|---|---|---|---|
| V-05, | — | | |
| Nisshinbo | | | |
| Chem. | | | |
| (solid content) | | | |
| V-07, | — | 5 | |
| Nisshinbo | | | |
| Chem. | | | |
| (solid content) | | | |
| V-09, | — | | 5 |
| Nisshinbo | | | |
| Chem. | | | |
| (solid content) | | | |

| | | | | | | | | | |
|---|---|---|---|---|---|---|---|---|---|
| Characteristics | Solvent- | Dissolution in Mixed | P* | P | P | P | P | P | P |
| Evaluation | solubility | solvent of toluene | | | | | | | |
| | | and alcohols | | | | | | | |
| | Heat | No conduction between | P | P | P | P | P | P | P |
| | resistance | Plate and Bar after | | | | | | | |
| | | 24 hours at 85° C. | | | | | | | |

| | | | | | Compositions | | | | |
|---|---|---|---|---|---|---|---|---|---|
| Items | | | | | 21 | 22 | 23 | 24 | 25 |
| Proportion of | Resin | Copolyamide | TPAE31, | MP | 100 | | | | |
| ingredients | | | Fuji Kasei | 114° C. | | | | | |
| (parts by mass) | | | TPAE32, | MP | | 100 | 100 | 100 | 100 |
| | | | Fuji Kasei | 124° C. | | | | | |
| | | | TPAE33, | MP | | | | | |
| | | | Fuji Kasei | 106° C. | | | | | |
| | | | PA102A, | MP | | | | | |
| | | | Fuji Kasei | 146° C. | | | | | |
| | Flame | Metal phosphate | Exolit OP935, | — | | | | | |
| | retardant | | Clariant | | | | | | |
| | | Phosphate | FP2100J, | — | 150 | 150 | 150 | 150 | 150 |
| | | | Adeka | | | | | | |
| | | Melamine | Melapur | — | | | | | |
| | | polyphosphate | 200/70, Chiba | | | | | | |
| | | Melamine sulfate | Apinon-901, | — | | | | | |
| | | | Sanwa Chem. | | | | | | |
| | | 1,3,5-triazine | MC-5S, | — | 30 | | | | |
| | | derivative | Sakai Chem. | | | | | | |
| | | Calcium borate | UBP, | — | | 30 | | | |
| | | | Kinseimatec | | | | | | |
| | | Zinc stannate | Alcanex ZS, | — | | | 30 | | |
| | | | Mizusawa Chem. | | | | | | |
| | | Magnesium hydroxide | Kisuma 5L, | — | | | | 30 | |
| | | | Kyowa Chem. | | | | | | |
| | | Aluminum hydroxide | Higilite | — | | | | | 30 |
| | | | H-42S, Showa | | | | | | |
| | | | Denko | | | | | | |
| | Additive | Carbodiimide | V-03, | — | 5 | | | | 5 |
| | | | Nisshinbo | | | | | | |
| | | | Chem. | | | | | | |
| | | | (solid content) | | | | | | |

| | | | | |
|---|---|---|---|---|
| V-05, | — | 5 | | |
| Nisshinbo | | | | |
| Chem. | | | | |
| (solid content) | | | | |
| V-07, | — | | 5 | |
| Nisshinbo | | | | |
| Chem. | | | | |
| (solid content) | | | | |
| V-09, | — | | | 5 |
| Nisshinbo | | | | |
| Chem. | | | | |
| (solid content) | | | | |

| | | | | | | | |
|---|---|---|---|---|---|---|---|
| Characteristics | Solvent- | Dissolution in Mixed | P | P | P | P | P |
| Evaluation | solubility | solvent of toluene | | | | | |
| | | and alcohols | | | | | |
| | Heat | No conduction between | P | P | P | P | P |
| | resistance | Plate and Bar after | | | | | |
| | | 24 hours at 85° C. | | | | | |

*MP: melting point, P: passed

TABLE 3
Adhesive layer (Comparative Examples)

| | | | | | Compositions | | | | | |
|---|---|---|---|---|---|---|---|---|---|---|
| Items | | | | | 1 | 2 | 3 | 4 | 5 | 6 |
| Proportion of | Resin | Copolyamide | PA100, Fuji Kasei | MP 84° C. | 100 | 100 | 100 | | | |
| ingredients | | | TPAE8, Fuji Kasei | MP 153° C. | | | | 100 | | |
| (parts by mass) | | Thermoplastic | UR-1350, Toyobo | MP N/A | | | | | 100 | |
| | | polyurethane | | | | | | | | |
| | | Amorphous polyester | Vylon 200, Toyobo | MP N/A | | | | | | 100 |
| | Flame | Metal phosphate | Exolit OP935, Clariant | — | 95 | | | | | 150 |
| | retardant | Phosphate | FP2100J, Adeka | — | | 150 | | | | |
| | | Melamine | Melapur 200/70, Chiba | — | | | 150 | 100 | | |
| | | polyphosphate | | | | | | | | |
| | | Melamine sulfate | Apinon-901, Sanwa Chem. | — | | | | | 100 | |
| | Additive | Carbodiimid | V-03, Nisshinbo Chem. | — | | | 10 | | | |
| | | | V-05, Nisshinbo Chem. | — | | | | | | 10 |

| | | | | | | | | |
|---|---|---|---|---|---|---|---|---|
| Characteristics | Solvent-solubility | Dissolution in mixed solvent of | P* | P | P | F | F | P |
| Evaluation | | toluene and alcohols | | | | | | |
| | Heat resistance | No conduction between plate and | F* | F | F | NE* | NE | F |
| | | bar after 24 hours at 85° C. | | | | | | |

*MP: melting point, P: passed, F: failed, NE: not evaluated

TABLE 4
Conductor adhesion layer

| | | | | | Compositions | | | |
|---|---|---|---|---|---|---|---|---|
| Items | | | | | A | B | C | D |
| Proportion of | Resin | Polyester | Vylon 670, Toyobo | MP N/A | 70 | | | 70 |
| ingredients | | | Vylon 200, Toyobo | MP N/A | 30 | | | 30 |
| (parts by mass) | | Thermoplastic polyurethane | UR-1350, Toyobo | MP N/A | | 100 | | |
| | | Copolyamide | TPAE32, Fuji Kasei | MP 124° C. | | | 100 | |
| | Flame | Magnesium hydroxide | Kisuma 5L, Kyowa Chem. | — | 50 | | | |
| | retardant | 1,3,5-triazine derivative | MC-5S, Sakai Chem. | — | | 50 | | |
| | | Metal phosphate | Exolit OP935, Clariant | — | | | 50 | |

| | | | | | | |
|---|---|---|---|---|---|---|
| Characteristics | Solvent-solubility | Dissolution in solvent having a boiling | P* | P | P | P |
| Evaluation | | point of not more than 120° C. | | | | |

*MP: melting point, P: passed

TABLE 5

| | | | Examples | | | | | | | | | | | | |
|---|---|---|---|---|---|---|---|---|---|---|---|---|---|---|---|
| Items | | | 1 | 2 | 3 | 4 | 5 | 6 | 7 | 8 | 9 | 10 | 11 | 12 | 13 |
| Adhesive | Conductor | Compositions | A | B | C | D | A | B | C | D | A | B | C | D | A |
| used | adhesion layer | | | | | | | | | | | | | | |
| | Adhesive layer | Compositions | 1 | 2 | 3 | 4 | 5 | 6 | 7 | 8 | 9 | 10 | 11 | 12 | 13 |

| | | | | | | | | | | | | | | |
|---|---|---|---|---|---|---|---|---|---|---|---|---|---|---|
| Evaluation | Solvent-solubility | P* | P | P | P | P | P | P | P | P | P | P | P | P |
| results | Heat resistance | P | P | P | P | P | P | P | P | P | P | P | P | P |
| | Adhesion | ⊚ | ⊚ | ⊚ | ⊚ | ⊚ | ⊚ | ⊚ | ⊚ | ◯ | ⊚ | ◯ | ⊚ | ◯ |
| | Flame retardancy | ⊚ | ◯ | ⊚ | ◯ | ⊚ | ◯ | ⊚ | ◯ | ⊚ | ◯ | ⊚ | ◯ | ⊚ |

*P: passed

TABLE 6

| | | | Examples | | | | | | | | | | | |
|---|---|---|---|---|---|---|---|---|---|---|---|---|---|---|
| Items | | | 14 | 15 | 16 | 17 | 18 | 19 | 20 | 21 | 22 | 23 | 24 | 25 |
| Adhesive | Conductor | Compositions | B | C | D | A | B | C | D | A | B | C | D | A |
| used | adhesion layer | | | | | | | | | | | | | |
| | Adhesive layer | Compositions | 14 | 15 | 16 | 17 | 18 | 19 | 20 | 21 | 22 | 23 | 24 | 25 |

| | | | | | | | | | | | | | |
|---|---|---|---|---|---|---|---|---|---|---|---|---|---|
| Evaluation | Solvent-solubility | P* | P | P | P | P | P | P | P | P | P | P | P |
| results | Heat resistance | P | P | P | P | P | P | P | P | P | P | P | P |
| | Adhesion | ⊚ | ◯ | ◯ | ⊚ | ⊚ | ◯ | Δ | ⊚ | ⊚ | ⊚ | ⊚ | ⊚ |
| | Flame retardancy | ◯ | ⊚ | ◯ | ⊚ | ◯ | ⊚ | ◯ | ⊚ | ◯ | ⊚ | ◯ | ⊚ |

*P: passed

TABLE 7

| | | | Comparative Examples | | | | | |
|---|---|---|---|---|---|---|---|---|
| Items | | | 1 | 2 | 3 | 4 | 5 | 6 |
| Adhesive | Conductor | Compositions | A | B | C | | | B |
| used | adhesion layer | | | | | | | |
| | Adhesive layer | Compositions | 26 | 27 | 28 | 29 | 30 | 31 |

| | | | | | | | |
|---|---|---|---|---|---|---|---|
| Evaluation | Solvent-solubility | P | P | P | F | F | P |
| results | Heat resistance | F | F | F | NE | NE | F |
| | Adhesion | Δ | X | ⊚ | NE | NE | ⊚ |
| | Flame retardancy | X | ◯ | ◯ | NE | NE | ◯ |

(*): P: passed, F: failed, NE: not evaluated

What is claimed is:

1. An adhesive film, comprising:
an insulation film;
an adhesive layer formed on the insulation film and comprising a copolyamide resin being soluble in a solvent at a room temperature (25° C.) and having a melting point of not less than 100° C. and not more than 150° C., a halogen-free flame retardant at a rate of not less than 100 parts by mass and not more than 250 parts by mass relative to 100 parts by mass of the copolyamide resin, and a carbodiimide compound soluble in the solvent at the room temperature (25° C.); and
a conductor adhesion layer laminated on the adhesive layer.

2. The adhesive film according to claim 1, wherein the solvent that the copolyamide resin in the adhesive layer is soluble therein comprises a mixed solvent of two solvents having a boiling point of not more than 140° C. and not containing halogen.

3. The adhesive film according to claim 2, wherein the mixed solvent comprises a mixture of toluene and an alcohol or a mixture of methylcyclohexane and n-propyl alcohol.

4. The adhesive film according to claim 1, wherein the halogen-free flame retardant in the adhesive layer comprises one or more flame retardants selected from the group consisting of a phosphorus compound, a nitrogen compound and a metal compound.

5. The adhesive film according to claim 1, wherein the carbodiimide compound in the adhesive layer is contained at a rate of not less than 2.5 parts by mass and not more than 15 parts by mass relative to 100 parts by mass of the copolyamide resin.

6. The adhesive film according to claim 1, wherein the conductor adhesion layer comprises a halogen-free solvent-soluble resin that is soluble in a solvent having a boiling point of not more than 120° C. and not containing halogen.

7. The adhesive film according to claim 6, wherein the conductor adhesion layer further comprises not less than 5 parts by mass and not more than 100 parts by mass of a halogen-free flame retardant relative to 100 parts by mass of the halogen-free solvent-soluble resin.

8. The adhesive film according to claim 7, wherein the halogen-free flame retardant in the conductor adhesion layer comprises one or more flame retardants selected from the group consisting of a phosphorus compound, a nitrogen compound and a metal compound.

9. The adhesive film according to claim 1, wherein the insulation film comprises a polyethylene terephthalate film having a thickness of not less than 9 μm and not more than 35 μm.

10. A flat cable, comprising:
a conductor; and
a pair of adhesive films each comprising: an insulation film; an adhesive layer formed on the insulation film; and a conductor adhesion layer laminated on the adhesive layer, the adhesive layer comprising a copolyamide resin being soluble in a solvent at a room temperature (25° C.) and having a melting point of not less than 100° C. and not more than 150° C., a halogen-free flame retardant at a rate of not less than 100 parts by mass and not more than 250 parts by mass per 100 parts by mass of the copolyamide resin, and a carbodiimide compound soluble in the solvent at the room temperature (25° C.),
wherein the pair of adhesive films are arranged such that the conductor adhesion layers face each other and are bonded to each other with the conductor interposed therebetween to cover the conductor.
